(19) United States
(12) Patent Application Publication
(10) Pub. No.: US 2026/0208294 A1
(43) Pub. Date: Jul. 23, 2026

(54) METHOD FOR MANUFACTURING A DOUBLE-SKINNED PLATE INCORPORATING CIRCULATION CHANNELS AND PLATE OBTAINED THEREBY

(71) Applicant: SOGEFI AIR & COOLING, GUYANCOURT (FR)

(72) Inventors: Stephen THOMPSON, ST-BRUNO-DE-MONTARVILLE (CA); Victor DIGIROLAMO, MONTREAL (CA); Nuno DEMETRIO-SOEIRO, LAVAL (CA); Nicolas BECKER, PORTE-DU-RIED (CA); Hervé MICHEL, CHATENOIS (FR)

(21) Appl. No.: 19/142,629

(22) PCT Filed: Dec. 18, 2023
(86) PCT No.: PCT/EP2023/086291

§ 371 Date: Jun. 23, 2025

(30) Foreign Application Priority Data
Dec. 22, 2022 (FR) 2214209

(51) Int. Cl. B23K 26/21; F28F 9/00; H01M 10/6568

(52) U.S. Cl. CPC B23K 26/21; F28F 9/001; H01M 10/6568; H01M 2220/20

(57) ABSTRACT

A method for manufacturing a double-skinned plate (1) incorporating channels (2) constituting at least one fluid circulation network or circuit. The method includes a first step of providing two flat aluminium sheets (3 and 3′), followed by a step of joining them together by laser welding, according to a linear pattern (4) tracing the pattern of the circulation channels (2), the two flat aluminium sheets (3 and 3′) into a double-skinned plate (1). There is another step of forming the circulation channels (2) by injecting a pressurized liquid or gaseous fluid (LP) between the two sheets (3 and 3′). The method also includes a step of flattening the plate (1) having the two sheets (3 and 3′) joined together by laser welding before the step of forming, by pressure deformation, the circulation channels (2).

The present invention relates to the field of equipment for temperature control, in particular by direct contact, and in particular in the form of a plate, with a preferred application in the field of battery housings for electric or hybrid vehicles.

The present invention more specifically relates to an improved method for manufacturing such a plate, an installation for the implementation thereof, the plate obtained and the housing comprising said plate.

Batteries which are currently used in electric and hybrid vehicles have to be temperature-controlled, in particular during their charging or discharging phases. This is the case, in particular, for Li-ion batteries, the operating temperature thereof having to be kept between 10° C. and 30° C.

In order to be able to carry out this temperature control, the most common solution is the use of a control plate or cooling plate in contact with the cells of the battery and generally arranged in the base of the housing thereof. This plate, which has a double-skinned structure made of aluminum, comprises passages in the form of channels which are arranged in a network or networks and which permit the circulation of a heat transfer fluid, for example water with added glycol.

Three different manufacturing techniques are currently used to produce these plates, namely i) joining two preformed aluminum sheets by brazing, ii) joining two aluminum sheets comprising an interlayer of ink by rolling, the pattern thereof corresponding to the circulation paths, and which permits a local separation of the sheets during a subsequent hydroforming operation and iii) directly extruding the plate with the circulation channels (so-called “micro port extrusion” technique, limited applications and complex and difficult implementation).

The implementation of a method for joining by brazing or rolling has the drawback of generating significant heat which can reduce the mechanical qualities of the aluminum, of consuming a large amount of energy and of requiring additional metal or a coating with a specific alloy for the sheets to be joined (for the brazing). Moreover, the precise joining of preformed sheets is difficult to carry out and the residual strain and stresses caused by the preforming in these sheets negatively impacts the final double-skinned plate, in particular in terms of contact between the plates during the brazing method. Moreover, this method requires complex clamping tools in order to ensure a sufficient quality of the joint.

A method for manufacturing a double-skinned plate incorporating channels constituting at least one fluid circulation network or circuit (F) is disclosed in the document DE 102017005325. This plate constitutes a temperature control plate for a battery housing.

The method as disclosed by this document DE essentially comprises a first step of providing two flat sheets made of aluminum or an aluminum-based alloy, followed by a second step of joining together by laser welding said two sheets into a double-skinned plate, according to a linear pattern tracing the pattern of the circulation channels, and finally a third step of forming said circulation channels by injecting a pressurized fluid between the two sheets so as to deform the zones of one of the sheets, these deformed zones corresponding to said channels and extending between the weld lines of the linear pattern. This last operation is carried out in a forming mold in order to control the final shape of the channels obtained and to limit undesired deformations.

By previously joining the aluminum sheets by laser welding, the method disclosed in this document DE enables the principal limitations of the aforementioned manufacturing techniques to be remedied, the laser welding not significantly changing the mechanical properties of the sheets, consuming less energy and not requiring additional material.

However, although the strain and stresses are significantly reduced by this method, the fact remains that the laser welding still causes certain distortions due to the phenomena of asymmetric thermal expansion and heating of the two sheets (one directly exposed to the laser beam, the other not) which are found in the final plate and affects its geometry and temperature behavior.

The principal object of the present invention is to remedy these remaining drawbacks.

To this end, a further subject of the invention is a method as mentioned above, characterized in that it also comprises a step of leveling or flattening the plate, consisting of the two sheets joined by laser welding, before the step of forming, by pressure deformation, the circulation channels.

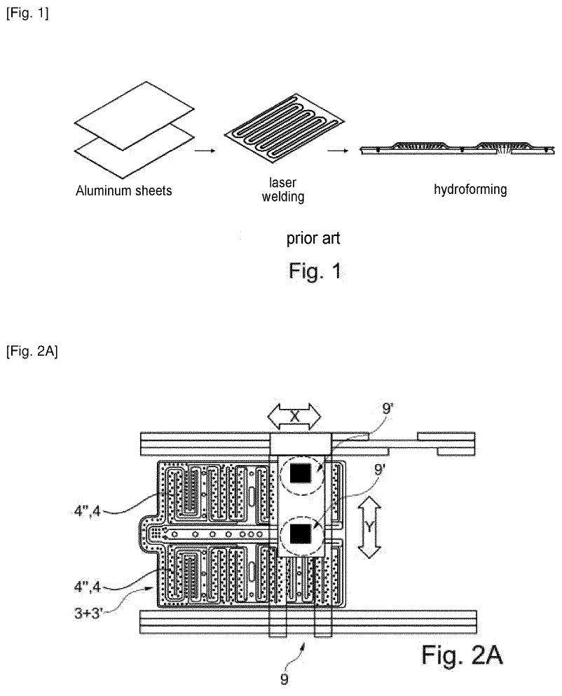

The invention will be understood more clearly by the following description which relates to preferred embodiments, provided by way of non-limiting examples and explained with reference to the accompanying schematic drawings, in which:
FIG. 1 is a schematic view of the three steps of the method for manufacturing according to the prior art corresponding to the aforementioned document DE;

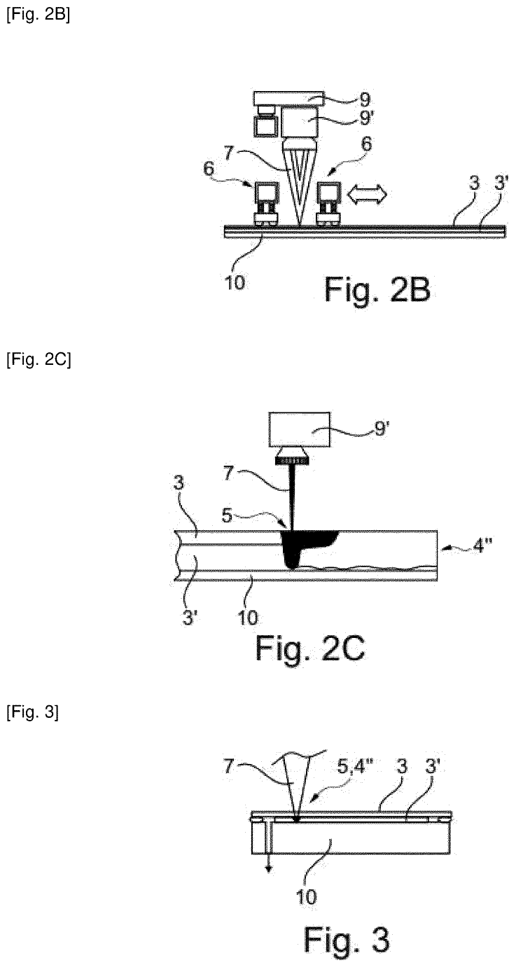

FIG. 2A,

FIG. 2B AND

FIG. 2C respectively show a view from above of a laser welding station in the form of a gantry with two laser heads which are mobile in one plane according to an embodiment of the invention (2A), a partial view in side elevation in the region of a mobile laser head of the station of FIG. 2A (this station being provided with a first variant of mobile local clamping means) (2B), and a detailed and partially sectional view illustrating the formation of a weld line with the mobile laser head of FIG. 2B (2C);

FIG. 3 shows a sectional view similar to that of FIG. 2B but illustrating the implementation of a further variant of clamping means which can be used in relation to the station of FIG. 2A;

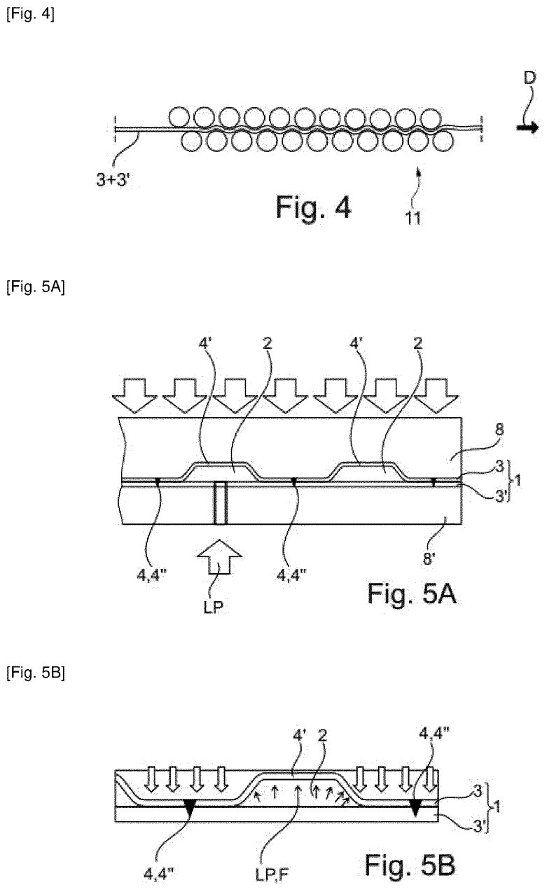

FIG. 4 illustrates schematically an intermediate leveling station according to the invention, processing the plate blank before the forming thereof;

FIG. 5A is a partial and sectional view of a forming mold capturing a plate during its forming operation, by the injection of pressurized liquid or gas, and

FIG. 5B is a detailed view of a part of the plate of FIG. 5A, illustrating the pressure forces prevailing during the forming operation.

The invention thus relates to a method for manufacturing a double-skinned plate (1) incorporating channels (2) constituting at least one fluid circulation network or circuit (F), in particular a temperature control plate for a battery housing.

This method essentially comprises a first step of providing two flat sheets or metal sheets (3 and 3′) made of aluminum or an aluminum-based alloy, followed by a step of joining together by laser welding said two sheets (3 and 3′) into a double-skinned plate (1), according to a linear pattern (4) tracing the pattern of the circulation channels (2), and finally a step of forming said circulation channels (2) by injecting a pressurized liquid or gaseous fluid (LP) between the two sheets (3 and 3′) so as to deform the zones (4′) of at least one of the sheets (3, 3′) which correspond to said channels (2) and which extend between the weld lines (4″) of the linear pattern (4). The joining of the two sheets or metal sheets by laser welding is carried out without the specific preheating thereof.

According to the invention, this method also comprises a step of leveling or flattening the plate (1), consisting of the two sheets (3 and 3′) joined by laser welding, before the step of forming (by pressure deformation) the circulation channels (2).

The invention eliminates the deformations and stresses induced in the plate (1) by thermal expansion during the laser welding operation, in particular due to the variable expansion of the two plates as a result of their different exposure to the heat source (only one being directly impacted by the laser), and said plate regains a similar flatness to the original flatness of the two sheets or metal sheets which constitute said plate.

According to an advantageous variant for implementing the invention, and as FIG. 4 shows, the step of leveling or flattening the plate (1), consisting of the two sheets (3 and 3′) joined by welding, is carried out by leveling (for example by means of a leveler of the servo-hydraulic or electromechanical type with two trains or layers of rollers, upper and lower, as shown in FIG. 4). This operation, during which the plate is displaced between two roller trains, makes it possible to eliminate the folds, the irregularities, the lack of flatness and the strain in the double-skinned plate (1) and thus in and between the two metal sheets or sheets (3 and 3′) which constitute said plate.

Preferably, and in order to be able to guarantee a priori the elimination of any deformation and any lack of flatness, the step of leveling or flattening by leveling a plate (1) comprises at least two successive passes in different passing or traveling directions (D) (for the plate in the leveling station). Preferably, and in order to reach a satisfactory compromise between speed of execution (productivity) and operational quality (elimination of stresses, deformations, defects), this step of flattening comprises two passes having different passing directions. Advantageously, the passing or traveling directions (D) of the different passes (two or more) are oriented between 30° and 90° relative to one another or relative to the others.

By carrying out this step of leveling or flattening in a specific station or machine, as indicated above, with a short process duration (only a few seconds per pass) and without using heat (no particular heating during this operation), the invention makes it possible not only to achieve a greater degree of flatness and an elimination of potential stresses and deformations but also to limit the energy requirements for this step and to achieve a virtually zero carbon footprint (approximately zero emission of CO2).

Relative to the flatness, the invention aims to achieve a lack of flatness of at most 1 cm per meter of length. However, since the flatness in the clamped state is highly dependent on the clamping possibilities and the distance between the fixing points, the invention aims to achieve a flatness in the order of mm, or less, on the aforementioned zones, depending on the clamping.

The joining by welding of the two aluminum sheets or metal sheets (3 and 3′), advantageously made of aluminum of the 3xxx or 5xxx series (easier to weld without the appearance of cracks when heated), is carried out for example by means of a fiber laser, with the implementation of a remote welding technique using a galvanometric scanner, making it possible to have a high welding speed. Alternatively, a laser head mounted on a robotic arm can be used.

The energy density and the focusing of the laser beam, and the other parameters of the welding method, are controlled such that the width of the weld line at the interface between the two sheets is between 0.7 and 1.0 mm. Since the weld lines can be several tens of meters in length (serpentine channels and two lines per channel), it is necessary to weld at high speed and high power, for industrial and economic reasons. Typically minimum powers in the order of 1 kW and speeds in the order of 6 m/min, preferably 10 to 20 m/min, are necessary.

According to a first embodiment of the invention, and as FIG. 2B shows, it can be provided that, during the course of the step of laser welding, the two sheets (3 and 3′) are kept pressed against one another locally on either side of the or each mobile laser welding point (5), for example by means of a pair of bearing or clamping means (6) displaced synchronously with the associated welding beam (7). As shown, the two means are displaced jointly with the laser beam and on either side thereof, leaving a passage window for the scanning and welding beams, for example in the order of 60 to 100 mm.

According to a second embodiment of the invention, and as FIG. 3 shows, it can be provided that, during the course of the step of laser welding, the two sheets (3 and 3′) are kept pressed against one another substantially over all of their respective mutually opposing surfaces, for example by vacuum suction clamping. This second embodiment does not require any mobile means with synchronized displacement.

Finally according to a third embodiment, not specifically shown but combining the solutions of the two first embodiments above, it can be provided that, during the course of the step of laser welding, the two sheets (3 and 3′) are kept pressed or clamped against one another, on the one hand generally and substantially over all of their respective mutually opposing surfaces and on the other hand locally on either side of the or each mobile laser welding point (5).

It can be noted that each of these clamping modes permits a thermal expansion of the sheets during the welding, which makes it possible to reduce significantly the formation of gaps resulting from the variable thermal expansion caused by the significant and asymmetrical application of energy, and leading to welding defects.

Relative to each of the three aforementioned embodiments, the joining by welding is carried out gradually from a central internal region of the plate (1) toward the peripheral zones thereof, by means of a single laser beam or at least two laser beams (7) displaced in a controlled manner.

Taking account of the energy density applied and to limit the phenomena of expansion, it can also be provided that, during the course of the step of laser welding the two sheets (3 and 3′), at least one thereof is subjected to a cooling action, for example by resting on a cooled welding table (10).

According to a further feature of the invention, and as illustrated in FIG. 5A by way of example, the step of forming the circulation channels (2) under hydraulic pressure is carried out by positioning the flat plate (1) into a mold (8, 8′) permitting a deformation, under internal pressure, of the zones (4′) of one (3) of the sheets (3, 3′), zones (4′) which correspond to said channels (2) and which extend between the weld lines (4″) of the linear pattern (4) relative to the other (3′) of said sheets (3, 3′).

As FIG. 5B shows more precisely, it is advantageously provided that, during the course of the step of forming the channels (2) by injecting a pressurized liquid or gaseous fluid (LP) between the two sheets (3 and 3′), a pressure (PC) is exerted on the first sheet or metal sheet (3) comprising the zones to be deformed (4′), so as to keep it in intimate contact with the other or second sheet or metal sheet (3′) in the region of all of the surface regions of this second sheet (3′), other than the zones to be deformed (4′), in particular in the region of the surface zones extending in strips on either side of the weld lines (4″). This second sheet (3′) rests and is advantageously held on a flat surface and thus not subjected to any deformation during the injection of the pressurized fluid (preservation of a flat external surface for this second sheet).

Hydroforming pressures suitable for the present method are between 6 and 30 MPa as a function of the thicknesses of the aluminum sheets, the grade and the minimum radii of curvature to be produced

The application of a pressure (PC) outside the zones (4′) to be deformed makes it possible to limit the stretching of the material of the sheet in these zones, and also helps to prevent any warping of the final plate. However, this pressure must not exceed the elastic limit of the aluminum.

The regions of the mold part (8) coming to bear in the surface zones extending in strips on either side of the weld lines can be textured on the surface in order to increase the grip in the contact interfaces, if required.

The invention also relates to an installation for implementing the method for manufacturing a double-skinned plate (1) incorporating channels (2) for the circulation of fluid (F), as described above.

Such an installation comprises at least: one welding station (9) with at least one laser beam, preferably at least two laser beams (7), displaced in a controlled manner and with one or more means (6) for clamping together the two plates (3 and 3′), generally and or locally, and advantageously a cooled welding table (10), a leveling or flattening station, advantageously a leveling station (11) with at least one roller leveler and a forming mold device (8, 8′) associated with a device for injecting pressurized liquid or gas (LP). In order to reduce the welding time, the station (9) can comprise two mobile laser heads, mounted on a gantry and guided by a scanner.

The invention also relates to a double-skinned plate (1), in particular a temperature control plate for a battery housing, formed by joining two aluminum sheets (3, 3′) by welding and incorporating channels (2) constituting at least one network or circuit for the circulation of fluid (F) of the heat transfer liquid type, said plate (1) being obtained by means of the aforementioned method for manufacturing, preferably by using the above-mentioned installation.

Finally, the invention also relates to a battery housing, in particular for a motor vehicle, comprising a cover and a base and possibly an intermediate partition wall, in contact with the cells of this battery, the housing being characterized in that least one element from said cover, said base and, if appropriate, said wall, is formed by a double-skinned plate (1) and with incorporated circulation channels as described above. A plate (1) according to the invention, possibly covered on its external face by an overmolded layer of plastics material, can thus in turn constitute the cover and/or the base of such a housing.

Naturally, the invention is not limited to the embodiments described and shown in the accompanying drawings. Modifications remain possible, in particular from the point of view of the constitution of the various elements or by the substitution of technical equivalents, without departing from the scope of protection of the invention.

1-12. (canceled)

13. A method for manufacturing a double-skinned plate incorporating channels having at least one fluid circulation network or circuit, in particular a temperature control plate for a battery housing, said method comprising the steps of:
providing two flat sheets or metal sheets, made of aluminum or an aluminum-based alloy,
joining together by laser welding said two sheets into a double-skinned plate, according to a linear pattern tracing the pattern of the circulation channels, and
forming said circulation channels by injecting a pressurized liquid or gaseous fluid between the two sheets so as to deform the zones of at least one of the sheets which correspond to said channels and which extend between the weld lines of the linear pattern,
said method further comprising leveling or flattening the plate, having the two sheets joined by laser welding, before the step of forming, by pressure deformation, the circulation channels and in that the step of leveling or flattening the plate, having the two sheets joined by welding, is carried out by leveling in a corresponding station and comprises at least two passes in different passing or traveling directions.

14. The method as claimed in claim 13, wherein the step of leveling or flattening the plate comprises two passes, with passing or traveling directions oriented between 30° and 90° relative to one another.

15. The method as claimed in claim 13, wherein, during the course of the step of laser welding, the two sheets are kept pressed against one another locally on either side of the or each mobile laser welding point, for example by means of a pair of bearing or clamping means displaced synchronously with the associated welding beam and in that the joining by welding is carried out gradually from a central internal region of the plate toward the peripheral zones thereof, by means of a single laser beam or at least two laser beams displaced in a controlled manner.

16. The method as claimed in claim 13, wherein, during the course of the step of laser welding, the two sheets are kept pressed against one another substantially over all of their respective mutually opposing surfaces, for example by vacuum suctioning clamping, and in that the joining by welding is carried out gradually from a central internal region of the plate toward the peripheral zones thereof, by means of a single laser beam or at least two laser beams displaced in a controlled manner.

17. The method as claimed in claim 15, wherein, during the course of the step of laser welding, the two sheets are kept pressed or clamped against one another, on the one hand generally and substantially over all of their respective mutually opposing surfaces and on the other hand locally on either side of the or each mobile laser welding point.

18. The method as claimed in claim 13, wherein the step of forming the circulation channels under hydraulic pressure is carried out by positioning the flat plate into a mold permitting a deformation, under internal pressure, of the zones of one of the sheets, zones which correspond to said channels and which extend between the weld lines of the linear pattern relative to the other of said sheets.

19. The method as claimed in claim 13, wherein, during the course of the step of laser welding the two sheets, at least one thereof is subjected to a cooling action, for example by resting on a cooled welding table.

20. The method as claimed in claim 13, wherein, during the course of the step of forming the channels by injecting a pressurized liquid or gaseous fluid between the two sheets, a pressure is exerted on the sheet comprising the zones to be deformed, so as to keep it in intimate contact with the other sheet in the region of all of the surface regions of this sheet, other than the zones to be deformed, in particular in the region of the surface zones extending in strips on either side of the weld lines.

21. An installation for implementing the method for manufacturing a double-skinned plate incorporating channels for the circulation of fluid as claimed in claim 13, said installation comprising at least:
i) one welding station with at least one laser beam, displaced in a controlled manner and with one or more means for clamping together the two plates, generally and or locally, and advantageously a cooled welding table,
ii) a leveling or flattening station of the leveling station type, with at least one roller leveler comprising means making it possible to carry out for each plate at least two passes in different passing or traveling directions and configured to result in a lack of flatness of at most 1 cm per meter of length, and
iii) a forming mold device associated with a device for injecting pressurized liquid or gas.

22. A double-skinned plate, of the temperature control plate type for a battery housing, formed by joining two aluminum sheets by laser welding and incorporating channels constituting at least one network or circuit for the circulation of fluid of the heat transfer liquid type, the pattern of the circulation channels being traced by the linear welding pattern and resulting from the deformation of the zones of at least one of the sheets extending between the weld lines of said linear pattern, said plate having been subjected, before a step of forming the channels by deformation under pressure, to a step of leveling or flattening the plate by leveling in a suitable station, with at least two passes in different passing or traveling directions, such that said plate has a lack of flatness of at most 1 cm per meter of length.

23. A battery housing for a motor vehicle, comprising a cover and a base and possibly an intermediate partition wall, in contact with the cells of this battery, wherein at least one element from said cover, said base and, if appropriate, said wall, is formed by a double-skinned plate and with incorporated circulation channels, as claimed in claim 22.
